(19) United States
(12) Patent Application Publication
(10) Pub. No.: US 2024/0355537 A1
(43) Pub. Date: Oct. 24, 2024

(54) INDUCTOR COMPONENT AND INDUCTOR ARRAY

(71) Applicant: Murata Manufacturing Co., Ltd., Nagaokakyo-shi (JP)

(72) Inventors: Yoshimitsu USHIMI, Nagaokakyo-shi (JP); Koshi HIMEDA, Nagaokakyo-shi (JP); Kenji NISHIYAMA, Nagaokakyo-shi (JP); Hidehiko SASAKI, Nagaokakyo-shi (JP); Nobuyoshi ADACHI, Nagaokakyo-shi (JP)

(21) Appl. No.: 18/758,276

(22) Filed: Jun. 28, 2024

Related U.S. Application Data
(63) Continuation of application No. PCT/JP2023/002479, filed on Jan. 26, 2023.

(30) Foreign Application Priority Data
Feb. 7, 2022 (JP) 2022-017334

(51) Int. Cl. H01F 27/29; H01F 17/00; H01F 27/32

(52) U.S. Cl. CPC H01F 27/292; H01F 17/0013; H01F 27/324; H01F 2017/0073

(57) ABSTRACT

An inductor component includes an element body having a magnetic material, and a coil that is disposed inside the element body. The coil includes a coil wire that is spirally wound along an axis with a first end of the coil wire at a positive side of the axis and a second end of the coil wire at a negative side of the axis. At least one of a first end surface of the first end of the coil wire and a second end surface of the second end of the coil wire includes a recess, and a portion of the element body is located inside the recess.

### CROSS REFERENCE TO RELATED APPLICATIONS

This application is a continuation of International Application No. PCT/JP2023/002479, filed Jan. 26, 2023, which claims priority to Japanese Patent Application No. 2022-017334, filed Feb. 7, 2022, the entire contents of each of which are hereby incorporated by reference in their entirety.

### TECHNICAL FIELD

The present disclosure relates to an inductor component and an inductor array.

### BACKGROUND

In the related art, an inductor component is described in Japanese Unexamined Patent Application Publication No. 2010-123864. The inductor component described therein includes an element body having soft magnetism characteristics and a coil provided inside the element body. The coil is formed by spirally winding a plate-shaped flat conductor wire covered with an insulation coating film.

Incidentally, when the inductor component as in the related art is used after being actually manufactured, it has been found that there is room for improvement in an inductance value and there is room for improvement in adhesion between the element body and the coil.

### SUMMARY OF THE INVENTION

In view of the foregoing, the present disclosure provides an inductor component and an inductor array that improves an inductance value and improves adhesion between an element body and a coil.

According to some exemplary aspects of the present disclosure, an inductor component includes an element body of a magnetic material, and a coil that is disposed inside the element body. The coil includes a coil wire that is spirally wound along an axis with a first end of the coil wire at a positive side of the axis and a second end of the coil wire at a negative side of the axis. At least one of a first end surface of the first end of the coil wire and a second end surface of the second end of the coil wire includes a recess, and a portion of the element body is located inside the recess.

Here, when the coil wire includes a plurality of coil conductor layers laminated along the axis, a surface on one side of the coil conductor layer located on the one side (e.g., one of positive side and negative side) in the direction of the axis is referred to as a “first end surface”, and a surface on the other side of the coil conductor layer located on the other side (e.g., the other of positive side and negative side) in the direction of the axis is referred to as a “second end surface”. In addition, when the coil wire is formed to continuously proceed along the axis, a surface facing the one side in the direction of the axis of the coil wire when viewed from the one side in the direction of the axis is referred to as a “first end surface”, and a surface facing the other side in the direction of the axis of the coil wire when viewed from the other side in the direction of the axis is referred to as a “second end surface”.

According to an exemplary aspect, a portion of the element body is inside the recess of the coil wire. Therefore, a volume of the magnetic material can be increased, and an inductance value is improved. In addition, a portion of the element body is located inside the recess of the coil wire. Therefore, adhesion between the element body and the coil wire is improved by an anchor effect.

According to an exemplary aspect of the inductor component, the coil wire includes a plurality of coil conductor layers laminated along the axis, and a connection conductor layer that connects the coil conductor layers adjacent to each other in the direction of the axis. Each of the plurality of coil conductor layers extends along a plane orthogonal to the axis. The plurality of coil conductor layers include a first coil conductor layer including the recess, and a second coil conductor layer adjacent to the first coil conductor layer in the direction of the axis. The connection conductor layer includes a first connection conductor layer that connects the first coil conductor layer and the second coil conductor layer. The recess and the first connection conductor layer overlap each other when viewed in the direction of the axis.

According to the exemplary embodiment, the recess and the first connection conductor layer overlap each other in the direction of the axis. Therefore, the recess and the first connection conductor layer are located on the same section including the axis. In this manner, a sectional area of the coil wire can be secured, and electrical resistance of the coil wire can be reduced.

According to an exemplary aspect of the inductor component, in a section including the axis and intersecting the recess and the first connection conductor layer, a depth of the recess is the same as or larger than a thickness of the first connection conductor layer.

According to the exemplary embodiment, the depth of the recess is the same as or larger than the thickness of the first connection conductor layer. Therefore, the volume of the magnetic material can be further increased, and the inductance value is further improved. In addition, the depth of the recess is the same as or larger than the thickness of the first connection conductor layer. Therefore, the anchor effect can be improved, and adhesion between the element body and the coil wire is further improved.

According to an exemplary aspect of the inductor component, in the section including the axis and intersecting the recess and the first connection conductor layer, an opening width of the recess is the same as or larger than a width of the first connection conductor layer.

According to the exemplary embodiment, the opening width of the recess is the same as or larger than the width of the first connection conductor layer. Therefore, the volume of the magnetic material can be further increased, and the inductance value is further improved. In addition, the opening width of the recess is the same as or larger than the width of the first connection conductor layer. Therefore, the anchor effect can be improved, and adhesion between the element body and the coil wire is further improved.

According to an exemplary aspect of the inductor component, the element body is formed of a composite material of a metal magnetic powder and an organic material.

According to the exemplary embodiment, DC superimposition characteristics can be improved by the metal magnetic powder. In addition, for example, when the inductor component is incorporated into a substrate, a resin elastically absorbs stress applied from the outside to reduce internal stress applied to the metal magnetic powder. In this manner, a reduction in an inductance value due to magnetic distortion is suppressed.

According to an exemplary aspect of the inductor component, the coil further includes an insulator that covers at least a portion of the coil wire. The insulator is formed of a composite material of a non-magnetic inorganic material and an organic material, or only the organic material.

According to the exemplary embodiment, for example, when the inductor component is incorporated into the substrate, the organic material of the insulator elastically absorbs the stress applied from the outside to reduce the internal stress applied to the metal magnetic powder. In this manner, a reduction in the inductance value due to magnetic distortion is suppressed.

According to an exemplary aspect of the inductor component, the inductor component further includes an external terminal provided on an outer surface of the element body and electrically connected to the coil.

In this aspect, it is noted that the position on the outer surface includes not only a position (on) directly above a portion in contact with the outer surface but also a position (above) separated from the outer surface, that is, an upper side position with another object on the outer surface interposed therebetween or an upper side position with an interval therebetween.

According to the exemplary embodiment, the inductor component includes the external terminal. Therefore, when the inductor component is mounted in or on the mounting substrate, the inductor component can be easily connected to a wire of the mounting substrate.

According to an exemplary aspect of the inductor component, the inductor component further includes an insulating film disposed between a portion of the external terminal and the outer surface of the element body.

According to the exemplary embodiment, insulation properties between the external terminal and the coil are improved.

According to an exemplary aspect of the inductor component, the outer surface of the element body includes a first surface and a second surface which face each other. The external terminal includes a first external terminal provided on the first surface, and a second external terminal provided on the second surface. The first external terminal and the second external terminal have the same potential.

In this aspect, the position on the first surface includes not only a position (on) directly above a portion in contact with the first surface but also a position (above) separated from the first surface, that is, an upper side position with another object on the first surface interposed therebetween or an upper side position with an interval therebetween. The same applies to the position on the second surface.

According to the exemplary embodiment, when the inductor component is incorporated into the substrate to form an electronic circuit, the inductor component can be connected to the circuit from both the first surface and the second surface of the inductor component, and a size of the electronic circuit is reduced.

According to an exemplary aspect of an inductor array, the inductor array includes a plurality of the inductor components. The plurality of inductor components are arrayed on the same plane.

According to the exemplary embodiment, the thickness of the inductor component can become smaller to achieve a thinner inductor component. Therefore, the thickness of the inductor array can be made smaller.

According to the inductor component and the inductor array in the aspect of the present disclosure, the inductance value is improved, and adhesion between the element body and the coil is also improved.

### BRIEF DESCRIPTION OF DRAWINGS

FIG. 1 is a plan view showing a first exemplary embodiment of an inductor component.

FIG. 2 is a bottom view showing the first exemplary embodiment of the inductor component.

FIG. 3 is a sectional view taken along line A-A in FIG. 1.

FIG. 4 is a sectional view taken along line B-B in FIG. 1.

FIG. 5 is a sectional view taken along line C-C in FIG. 1.

FIG. 6 is an exploded plan view of a coil wire.

FIG. 7A is a sectional view for describing a manufacturing method for the inductor component.

FIG. 7B is a sectional view for describing the manufacturing method for the inductor component.

FIG. 7C is a sectional view for describing the manufacturing method for the inductor component.

FIG. 7D is a sectional view for describing the manufacturing method for the inductor component.

FIG. 7E is a sectional view for describing the manufacturing method for the inductor component.

FIG. 7F is a sectional view for describing the manufacturing method for the inductor component.

FIG. 7G is a sectional view for describing the manufacturing method for the inductor component.

FIG. 7H is a sectional view for describing the manufacturing method for the inductor component.

FIG. 7I is a sectional view for describing the manufacturing method for the inductor component.

FIG. 7J is a sectional view for describing the manufacturing method for the inductor component.

FIG. 7K is a sectional view for describing the manufacturing method for the inductor component.

FIG. 7L is a sectional view for describing the manufacturing method for the inductor component.

FIG. 7M is a sectional view for describing the manufacturing method for the inductor component.

FIG. 7N is a sectional view for describing the manufacturing method for the inductor component.

FIG. 7O is a sectional view for describing the manufacturing method for the inductor component.

FIG. 8 is a plan view showing a second exemplary embodiment of an inductor component.

FIG. 9 is a sectional view taken along line A-A in FIG. 8.

FIG. 10 is a sectional view taken along line B-B in FIG. 8.

FIG. 11 is an exploded plan view of a coil wire.

FIG. 12 is a partially enlarged view of FIG. 10.

FIG. 13 is a plan view showing an exemplary embodiment of an inductor array.

FIG. 14 is a sectional view showing a state where the inductor array is incorporated into a substrate.

FIG. 15 is a plan view showing an exemplary embodiment of an inductor array.

### DETAILED DESCRIPTION OF EMBODIMENTS

Hereinafter, an inductor component according to an exemplary aspect of the present disclosure will be described in detail with reference to exemplary embodiments shown in the drawings. The drawings partially include schematic views and do not reflect actual dimensions or ratios.

### First Exemplary Embodiment

### Schematic Configuration

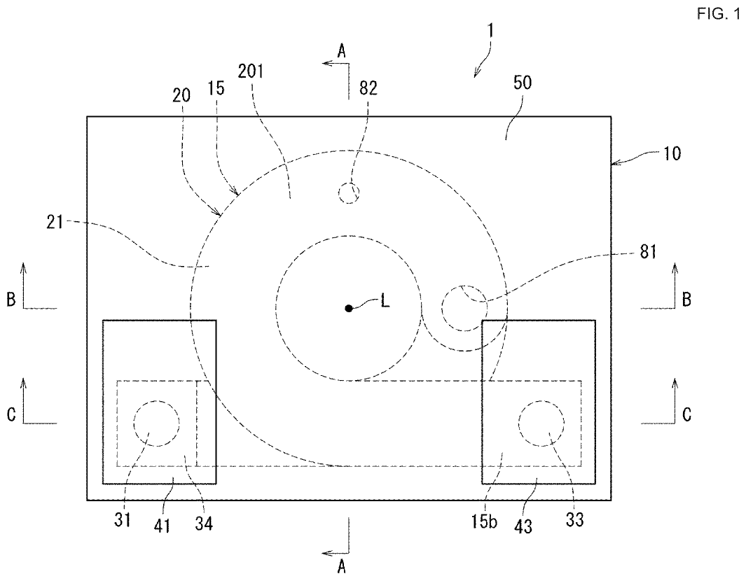

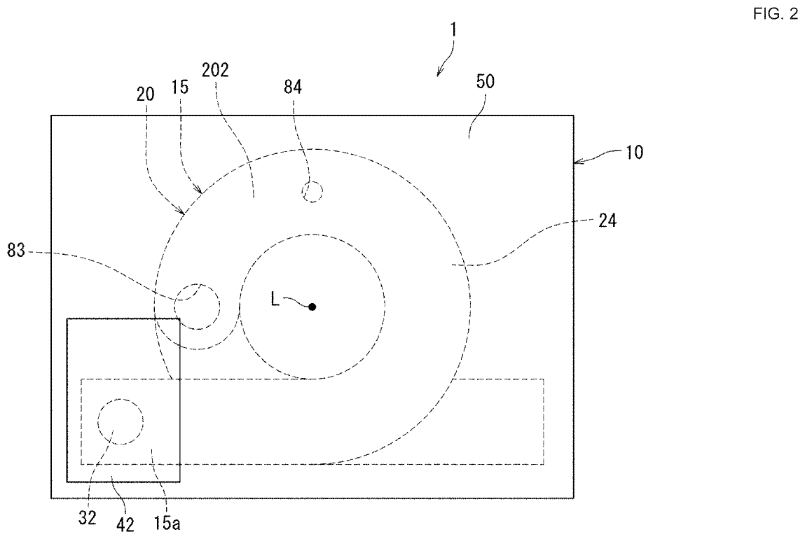

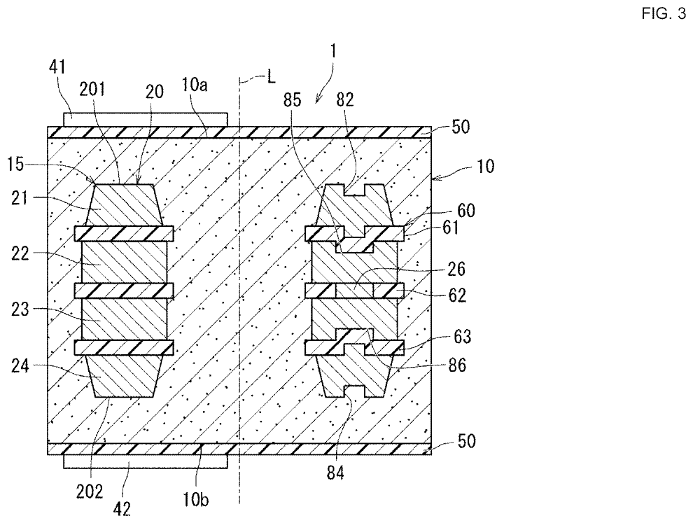

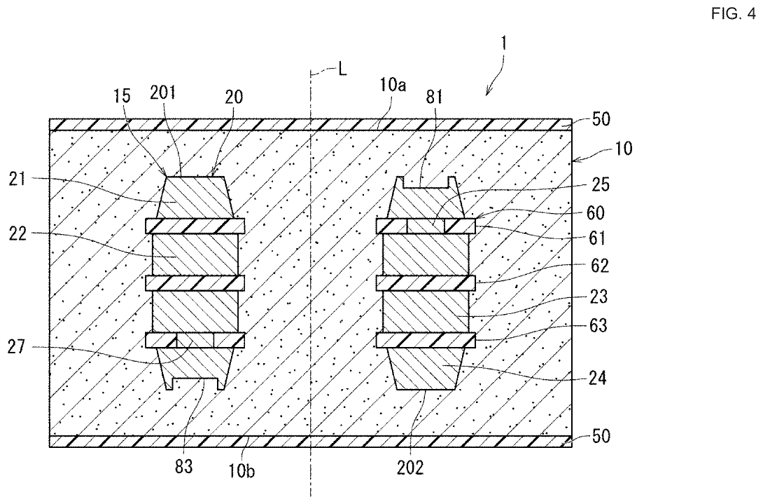

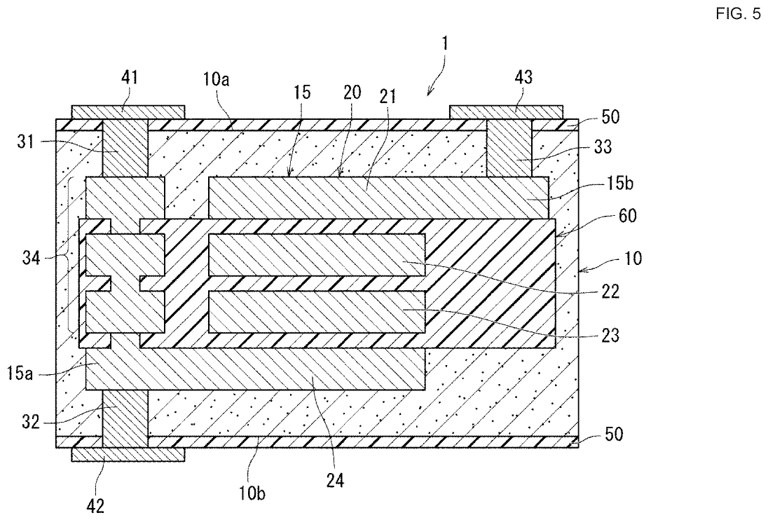

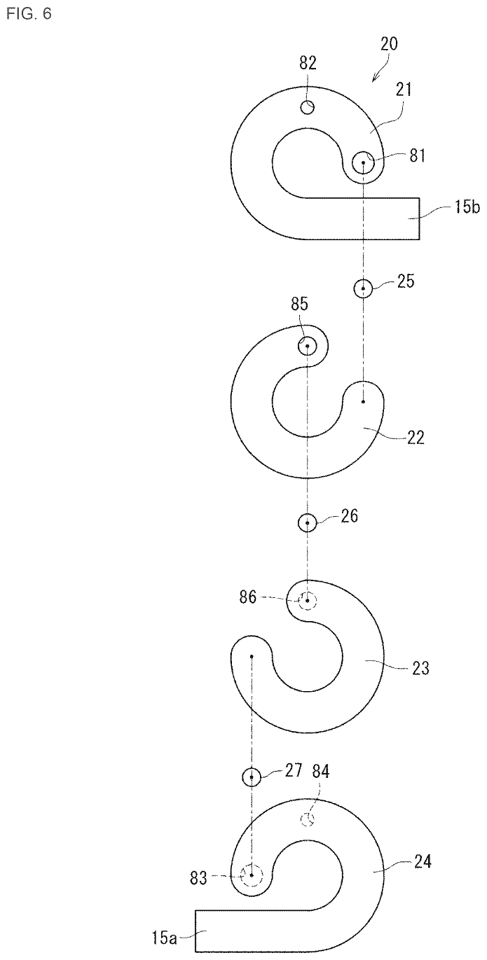

FIG. 1 is a plan view showing a first embodiment of an inductor component. FIG. 2 is a bottom view showing the first embodiment of the inductor component. FIG. 3 is a sectional view taken along line A-A in FIG. 1. FIG. 4 is a sectional view taken along line B-B in FIG. 1. FIG. 5 is a sectional view taken along line C-C in FIG. 1. FIG. 6 is an exploded plan view of a coil.

For example, an inductor component 1 is mounted on electronic devices such as a personal computer, a DVD player, a digital camera, a TV, a mobile phone, and car electronics, and for example, is a component having a rectangular parallelepiped shape as a whole. However, the shape of the inductor component 1 is not particularly limited and may be a columnar shape, a polygonal columnar shape, a frustum shape, or a polygonal frustum shape.

As shown in FIGS. 1, 2, 3, and 4, the inductor component 1 includes an element body 10 including a magnetic material, and a coil 15 disposed inside the element body 10. The coil 15 includes a coil wire 20 spirally wound along an axis L.

The coil wire 20 includes a plurality of coil conductor layers 21, 22, 23, and 24 (also referred to as coil conductor layer portions) laminated along the axis L. According to an exemplary aspect, the first coil conductor layer 21, the second coil conductor layer 22, the third coil conductor layer 23, and the fourth coil conductor layer 24 are disposed in this order from an upper side to a lower side along the axis L.

At least one end surface of a first end surface 201 on one side of the coil wire 20 in a direction of the axis L and a second end surface 202 on the other side of the coil wire 20 in the direction of the axis L includes recesses 81, 82, 83, and 84. A portion of the element body 10 is located inside the recesses 81, 82, 83, and 84.

In the present exemplary embodiment, one side in the direction of the axis L refers to the upper side (also referred to as positive side of the axis), and the other side in the direction of the axis L refers to the lower side (also referred to as negative side of the axis). That is, the first end surface 201 is a surface on one side of the first coil conductor layer 21 located on the one side in the direction of the axis L, and the second end surface 202 is a surface on the other side of the fourth coil conductor layer 24 located on the other side in the direction of the axis L. The first recess 81 and the second recess 82 are provided in the first end surface 201, and the third recess 83 and the fourth recess 84 are provided in the second end surface 202.

When the coil wire is formed to continuously proceed along the axis, the first end surface is a surface facing the one side in the direction of the axis of the coil wire when viewed from the one side in the direction of the axis. That is, the first end surface is a surface exposed to be visually recognizable when viewed from the one side in the direction of the axis when the coil wire is focused on. Similarly, the second end surface is a surface facing the other side in the direction of the axis of the coil wire when viewed from the other side in the direction of the axis. That is, the second end surface is a surface exposed to be visually recognizable when viewed from the other side in the direction of the axis when the coil wire is focused on.

According to the above-described configuration, a portion of the element body 10 is located inside the recesses 81, 82, 83, and 84 of the coil wire 20. Therefore, a volume of the magnetic material can be increased, and an inductance value is improved. In addition, a portion of the element body 10 is located inside the recesses 81, 82, 83, and 84 of the coil wire 20. Therefore, adhesion between the element body 10 and the coil wire 20 is improved by an anchor effect.

In addition, the coil wire 20 includes the recesses 81, 82, 83, and 84. Therefore, a surface area of the coil wire 20 is increased. In this manner, an outer peripheral length of a section of the coil wire 20 can be increased with respect to a sectional area of the coil wire 20. As a result, it is possible to obtain the inductor component 1 having a small loss and which can suppress an AC resistance increase caused by a skin effect.

### Exemplary Configuration

As shown in FIGS. 1 to 5, the inductor component 1 further includes a first external terminal 41, a second external terminal 42, and a third external terminal 43 which are provided on an outer surface of the element body 15 and are electrically connected to the coil 15, and an insulating film 50 disposed between each portion of the first external terminal 41, the second external terminal 42, and the third external terminal 43 and the outer surface of the element body 10.

According to the above-described configuration, the inductor component 1 includes the external terminals 41 to 43. Therefore, when the inductor component 1 is mounted in or on a mounting substrate (not shown), the inductor component 1 can be easily connected to a wire of the mounting substrate. In addition, the inductor component 1 includes the insulating film 50. Therefore, insulation properties between the external terminal 41 to 43 and the coil 15 are improved. In addition, the insulating film 50 is disposed in an outer side portion of the element body 10. Therefore, the insulating film 50 does not hinder the magnetic flux of the coil 15. In contrast, when the insulating film is provided inside the element body to ensure the insulation properties between the coil and the external terminal, there is a possibility that the insulating film hinders the magnetic flux of the coil.

The outer surface of the element body 10 includes a first surface 10a and a second surface 10b which face each other. The first surface 10a and the second surface 10b are orthogonal to the axis L of the coil 15. In the present exemplary embodiment, the first surface 10a is the upper surface, and the second surface 10b is the lower surface.

The element body 10 is formed of a composite material of a metal magnetic powder and an organic material. For example, the metal magnetic powder is formed of a FeSi-based alloy such as FeSiCr, a FeCo-based alloy, a Fe-based alloy such as NiFe, or an amorphous alloy thereof. For example, the organic material is formed of an epoxy resin, an acrylic resin, a phenol resin, a polyimide resin, a liquid crystal polymer, or a combination thereof.

According to the above-described configuration, DC superimposition characteristics is improved by the metal magnetic powder. In addition, for example, when the inductor component 1 is incorporated into the substrate, the resin elastically absorbs stress applied from the outside to reduce internal stress applied to the metal magnetic powder. In this manner, it is possible to suppress a reduction in an inductance value due to magnetic distortion. The element body may be ferrite or a sintered body of a magnetic powder. In other words, the element body may be made of a material that does not include an organic resin.

The coil 15 further includes an insulator 60 that covers at least a portion of the coil wire 20. In FIGS. 1 and 2, for convenience, the insulator 60 is omitted. For example, the insulator 60 is formed of a composite material of a non-magnetic inorganic material and an organic material, or only the organic material. For example, the organic material is formed of an epoxy resin, an acrylic resin, a phenol resin, a polyimide resin, a liquid crystal polymer, or a combination thereof. For example, the non-magnetic inorganic material is formed of a filler such as silica. Accordingly, for example, when the inductor component 1 is incorporated into the substrate, the organic material of the insulator 60 elastically absorbs stress applied from the outside to reduce internal stress applied to the metal magnetic powder. In this manner, it is possible to suppress a reduction in an inductance value due to magnetic distortion.

The insulator 60 may be a sintered body such as glass and alumina, or a thin film such as a silicon oxide film, a silicon nitride film, and a silicon oxynitride film. In addition, the insulator 60 may be a magnetic body instead of a non-magnetic body.

The coil 15 includes a first end portion 15a which is a lowermost end on the second surface 10b side, and a second end portion 15b which is an uppermost end on the first surface 10a side. A second extended wire 32 and a fourth extended wire 34 are connected to the coil wire 20 of the first end portion 15a. A third extended wire 33 is connected to the coil wire 20 of the second end portion 15b. A first extended wire 31 is connected to the fourth extended wire 34.

The fourth extended wire 34 extends from the first end portion 15a toward the first surface 10a side along the axis L. The first extended wire 31 extends from the fourth extended wire 34 toward the first surface 10a side along the axis L and is exposed from the first surface 10a and the insulating film 50. The second extended wire 32 extends from the first end portion 15a toward the second surface 10b side along the axis L. The second extended wire 32 is exposed from the second surface 10b and the insulating film 50. The third extended wire 33 extends from the second end portion 15b toward the first surface 10a side along the axis L. The third extended wire 33 is exposed from the first surface 10a and the insulating film 50.

The first external terminal 41 is provided on the first surface 10a and is connected to the first extended wire 31. The insulating film 50 is disposed between a portion of the first external terminal 41 and the first surface 10a. The second external terminal 42 is provided on the second surface 10b and is connected to the second extended wire 32. The insulating film 50 is disposed between a portion of the second external terminal 42 and the second surface 10b. The third external terminal 43 is provided on the first surface 10a and is connected to the third extended wire 33. The insulating film 50 is disposed between a portion of the third external terminal 43 and the first surface 10a.

The first external terminal 41 and the second external terminal 42 have the same potential. Accordingly, when the inductor component 1 is incorporated into the substrate to form an electronic circuit, the inductor component 1 can be connected to a circuit from both sides of the first surface 10a and the second surface 10b of the inductor component 1, and the size of the electronic circuit is reduced.

The second external terminal 42 and the second extended wire 32 do not need to be provided, and the first external terminal 41 and the third external terminal 43 may be provided. In addition, the third external terminal 43 may be provided on the second surface 10b instead of the first surface 10a. In addition, the first external terminal 41 and the third external terminal 43 may be brought into contact with the first surface 10a, and the second external terminal 42 may be brought into contact with the second surface 10b without providing the insulating film 50.

As shown in FIGS. 3, 4, and 6, the coil wire 20 includes the first coil conductor layer 21, the second coil conductor layer 22, the third coil conductor layer 23, and the fourth coil conductor layer 24 which are laminated along the axis L, a first connection conductor layer 25 (also referred to as a first connection conductor layer portion) that connects the first coil conductor layer 21 and the second coil conductor layer 22 which are adjacent to each other in the direction of the axis L, a second connection conductor layer 26 (also referred to as a second connection conductor layer portion) that connects the second coil conductor layer 22 and the third coil conductor layer 23 which are adjacent to each other in the direction of the axis L, and a third connection conductor layer 27 (also referred to as a third connection conductor layer portion) that connects the third coil conductor layer 23 and the fourth coil conductor layer 24 which are adjacent to each other in the direction of the axis L.

The first coil conductor layer 21, the second coil conductor layer 22, the third coil conductor layer 23, and the fourth coil conductor layer 24 are disposed downward from above in this order. Each of the first coil conductor layer 21, the second coil conductor layer 22, the third coil conductor layer 23, and the fourth coil conductor layer 24 extends along a plane orthogonal to the axis L. Each of the first coil conductor layer 21, the second coil conductor layer 22, the third coil conductor layer 23, and the fourth coil conductor layer 24 has a spiral shape smaller than one turn.

Each of the first connection conductor layer 25, the second connection conductor layer 26, and the third connection conductor layer 27 extends along the axis L. Each of the first connection conductor layer 25, the second connection conductor layer 26, and the third connection conductor layer 27 is formed in a disk shape.

One end of the first coil conductor layer 21 and one end of the second coil conductor layer 22 are connected in series with the first connection conductor layer 25 interposed therebetween, the other end of the second coil conductor layer 22 and one end of the third coil conductor layer 23 are connected in series with the second connection conductor layer 26 interposed therebetween, and the other end of the third coil conductor layer 23 and one end of the fourth coil conductor layer 24 are connected in series with the third connection conductor layer 27 interposed therebetween. The first coil conductor layer 21, the second coil conductor layer 22, the third coil conductor layer 23, and the fourth coil conductor layer 24 are electrically connected in series.

The first recess 81 and the second recess 82 are provided in the upper surface of the first coil conductor layer 21. The third recess 83 and the fourth recess 84 are provided in the lower surface of the fourth coil conductor layer 24. When viewed in the direction of the axis L, a diameter of the first recess 81 is larger than a diameter of the second recess 82, and a diameter of the third recess 83 is larger than a diameter of the fourth recess 84. In addition, the diameter of the first recess 81 is the same as the diameter of the third recess 83, and the diameter of the second recess 82 is the same as the diameter of the fourth recess 84.

The first recess 81 to the fourth recess 84 can be formed by control. For example, when the first coil conductor layer 21 and the fourth coil conductor layer 24 are formed through plating, the first recess 81 to the fourth recess 84 are formed by controlling plating conditions. For example, the plating conditions are current density, ion concentration in a plating bath, and the like. The first recess 81 to the fourth recess 84 may be mechanically formed through cutting, polishing, or the like.

The first recess 81 and the first connection conductor layer 25 overlap each other in the direction of the axis L. Accordingly, the first recess 81 and the first connection conductor layer 25 are located on the same section including the axis L. Therefore, the first coil conductor layer 21 includes the first recess 81, and a sectional area of the first coil conductor layer 21 is reduced. However, the first connection conductor layer 25 is connected to the first coil conductor layer 21. Therefore, the sectional area of the first coil conductor layer 21, that is, the coil wire 20 can be secured, and electrical resistance of the coil wire 20 is reduced.

Similarly, the third recess 83 and the third connection conductor layer 27 overlap each other when viewed in the direction of the axis L. Accordingly, the third recess 83 and the third connection conductor layer 27 are located on the same section including the axis L. Therefore, the fourth coil conductor layer 24 includes the third recess 83, and the sectional area of the fourth coil conductor layer 24 is reduced. However, the third connection conductor layer 27 is connected to the fourth coil conductor layer 24. Therefore, the sectional area of the fourth coil conductor layer 24, that is, the coil wire 20 can be secured, and electrical resistance of the coil wire 20 is reduced.

In addition, the second recess 82 and the second connection conductor layer 26 overlap each other when viewed in the direction of the axis L. Accordingly, the second recess 82 and the second connection conductor layer 26 are located on the same section including the axis L. Therefore, the sectional area of the coil wire 20 can be secured, and electrical resistance of the coil wire 20 is reduced. According to an exemplary aspect, a fifth recess 85 is provided in the upper surface of the second coil conductor layer 22 at a position overlapping the second connection conductor layer 26. The second recess 82 overlaps the fifth recess 85.

Similarly, the fourth recess 84 and the second connection conductor layer 26 overlap each other when viewed in the direction of the axis L. Accordingly, the fourth recess 84 and the second connection conductor layer 26 are located on the same section including the axis L. Therefore, the sectional area of the coil wire 20 can be secured, and electrical resistance of the coil wire 20 is reduced. According to an exemplary aspect, a sixth recess 86 is provided in the lower surface of the third coil conductor layer 23 at a position overlapping the second connection conductor layer 26. The fourth recess 84 overlaps the sixth recess 86.

The insulator 60 includes a first insulating layer 61, a second insulating layer 62, and a third insulating layer 63. The first insulating layer 61 is provided between the first coil conductor layer 21 and the second coil conductor layer 22. The second insulating layer 62 is provided between the second coil conductor layer 22 and the third coil conductor layer 23. The third insulating layer 63 is provided between the third coil conductor layer 23 and the fourth coil conductor layer 24. The first connection conductor layer 25 penetrates the first insulating layer 61. The second connection conductor layer 26 penetrates the second insulating layer 62. The third connection conductor layer 27 penetrates the third insulating layer 63.

The first insulating layer 61 is fitted into the fifth recess 85. The first insulating layer 61 includes a recess at a position corresponding to the fifth recess 85, and the first coil conductor layer 21 is fitted into the recess. Similarly, the third insulating layer 63 is fitted into the sixth recess 86. The third insulating layer 63 includes a recess at a position corresponding to the sixth recess 86, and the fourth coil conductor layer 24 is fitted into the recess.

### Manufacturing Method

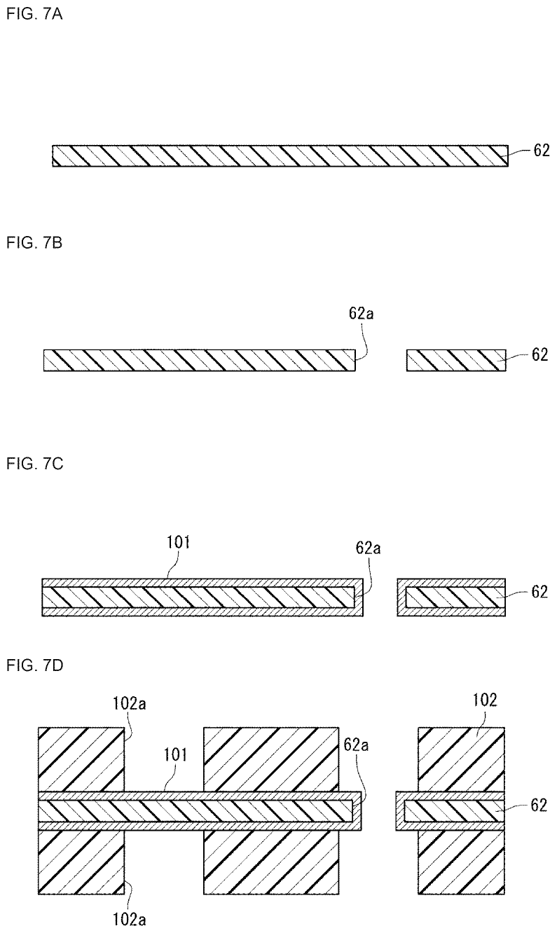

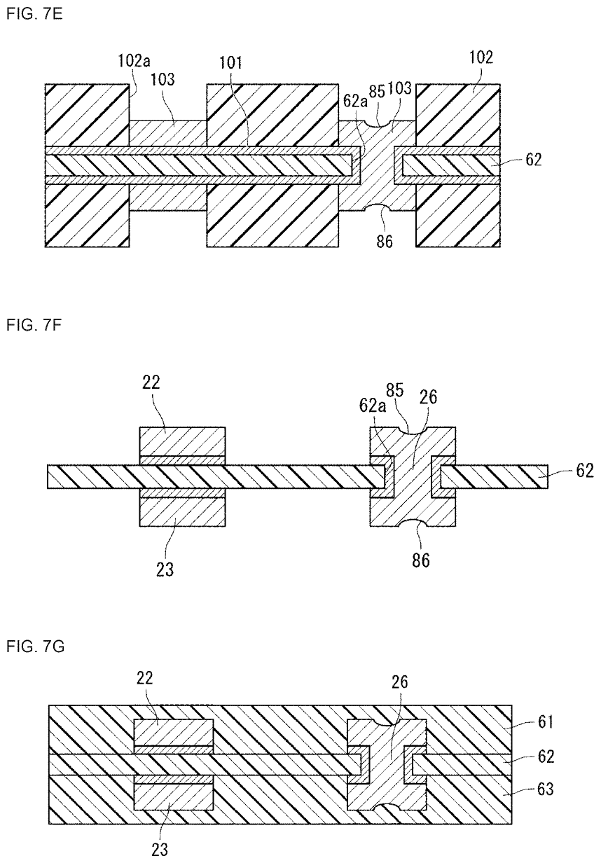

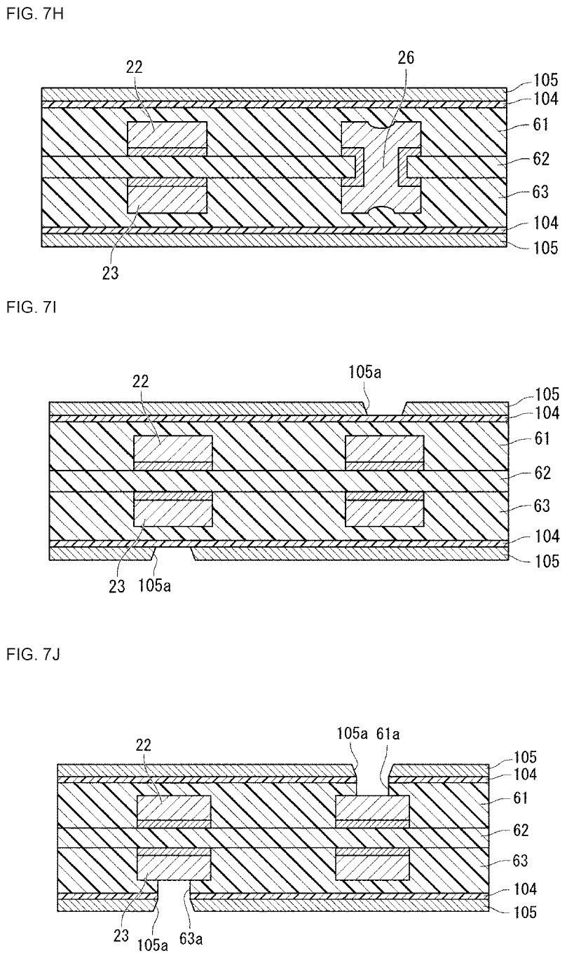

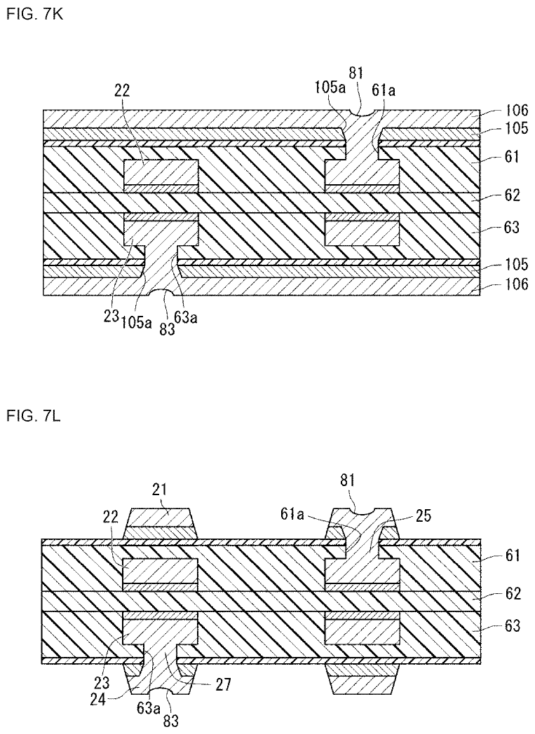

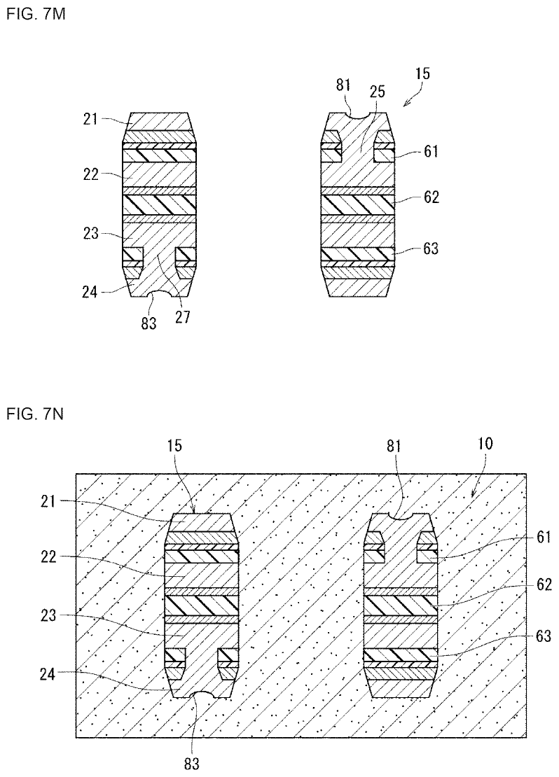

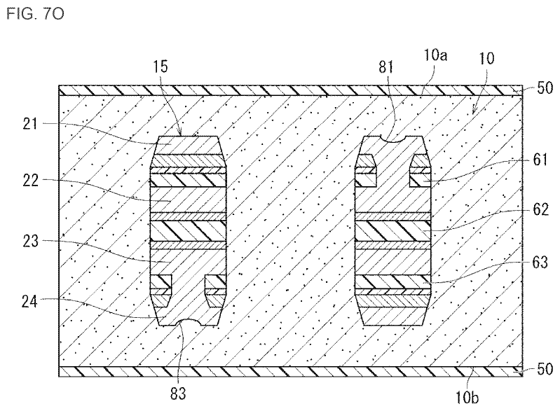

Next, a manufacturing method for the inductor component 1 will be described. FIGS. 7A to 7H correspond to a section taken along line A-A in FIG. 1. FIGS. 7I to 7O correspond to a section taken along line B-B in FIG. 1.

As shown in FIG. 7A, the second insulating layer 62 is prepared, and as shown in FIG. 7B, a portion of the second insulating layer 62 is removed through laser processing to form a through-hole 62a.

As shown in FIG. 7C, a seed layer 101 is formed on a front surface of the second insulating layer 62 through, for example, sputtering. The seed layer 101 is formed of, for example, Cu/Ti. The seed layer 101 is also formed on an inner surface of the through-hole 62a.

As shown in FIG. 7D, coil pattern portions 102a are formed on both surfaces of the second insulating layer 62 by using a photoresist 102. As shown in FIG. 7E, a metal film 103 is formed on the through-hole 62a and the coil pattern portion 102a through electrolytic plating. The metal film 103 is formed of Cu. In this case, plating conditions are controlled to form the fifth recess 85 and the sixth recess 86 in the metal film 103. For example, the plating conditions are current density, ion concentration in a plating bath, and the like.

As shown in FIG. 7F, the photoresist 102 is peeled off, and the exposed seed layer 101 is etched. The second coil conductor layer 22 is formed on the upper surface of the second insulating layer 62 by the seed layer 101 and the metal film 103, the third coil conductor layer 23 is formed on the lower surface of the second insulating layer 62, and the second connection conductor layer 26 is formed in the through-hole 62a of the second insulating layer 62. The fifth recess 85 is formed in the upper surface of the second coil conductor layer 22, and the sixth recess 86 is formed in the lower surface of the third coil conductor layer 23. Simultaneously when the second coil conductor layer 22 and the third coil conductor layer 23 are formed, a portion of the fourth extended wire 34 shown in FIG. 5 is formed.

As shown in FIG. 7G, the first insulating layer 61 is formed on the upper surface of the second insulating layer 62 to cover the second coil conductor layer 22, and the third insulating layer 63 is formed on the lower surface of the second insulating layer 62 to cover the third coil conductor layer 23. As shown in FIG. 7H, a metal foil 105 is attached to the upper surface of the first insulating layer 61 and the lower surface of the third insulating layer 63 with an adhesive layer 104 interposed therebetween. The metal foil 105 is formed of Cu.

As shown in FIG. 7I, a via pattern portion is formed by using a photoresist (not shown), and a via opening portion 105a is formed in the upper and lower metal foils 105 through etching. As shown in FIG. 7J, a position overlapping the upper side via opening portion 105a in the first insulating layer 61 and the adhesive layer 104 is removed through laser processing to form a via opening portion 61a. In addition, a position overlapping the lower side via opening portion 105a in the third insulating layer 63 and the adhesive layer 104 is removed through laser processing to form a via opening portion 63a.

As shown in FIG. 7K, a metal film 106 is formed in the via opening portions 61a, 63a, and 105a through electroless plating and electrolytic plating. That is, the electroless plating film is used as a power supply film of the electrolytic plating film. The metal film 106 is formed of Cu. In this case, plating conditions are controlled to form the first recess 81 and the third recess 83 in the metal film 106. For example, the plating conditions are current density, ion concentration in a plating bath, and the like. Although not shown, similarly, the second recess 82 and the fourth recess 84 are formed in the metal film 106.

As shown in FIG. 7L, a coil pattern portion is formed by using a photoresist (not shown), and the metal foil 105 and the metal film 106 are etched. The first coil conductor layer 21 is formed on the upper surface of the first insulating layer 61 by the metal foil 105 and the metal film 106, the fourth coil conductor layer 24 is formed on the lower surface of the third insulating layer 63, the first connection conductor layer 25 is formed in the via opening portion 61a of the first insulating layer 61, and the third connection conductor layer 27 is formed in the via opening portion 63a of the third insulating layer 63. The first recess 81 is formed in the upper surface of the first coil conductor layer 21, and the third recess 83 is formed in the lower surface of the fourth coil conductor layer 24. Simultaneously when the first coil conductor layer 21 is formed, a portion of the fourth extended wire 34 shown in FIG. 5 is formed. Simultaneously when the fourth coil conductor layer 24 is formed, the fourth extended wire 34 is connected to the fourth coil conductor layer 24.

As shown in FIG. 7M, the first insulating layer 61, the second insulating layer 62, and the third insulating layer 63 which are located in the inner magnetic path and the outer magnetic path and the adhesive layer 104 are removed through laser processing to form the coil 15. In this case, the coils 15 may be separated from each other, or a plurality of the coils 15 may be integrally connected.

As shown in FIG. 7N, a magnetic sheet formed of a composite material of the metal magnetic powder and the resin material is pressure-bonded to the coil 15 through vacuum pressing or vacuum lamination to cover the coil 15 with the element body 10. In this case, a portion of the element body 10 enters each of the first recess 81 to the fourth recess 84. The magnetic sheets may be simultaneously pressure-bonded to the coil 15 from above and below, or the magnetic sheets may be separately pressure-bonded to the coil 15 from above and below.

As shown in FIG. 7O, the insulating film 50 is formed on the first surface 10a and the second surface 10b of the element body 10. Thereafter, although not shown, a via opening portion is formed through laser processing, drilling, or the like at a position corresponding to the first external terminal 41, the second external terminal 42, and the third external terminal 43 in the insulating film 50 and the element body 10. The first extended wire 31, the second extended wire 32, and the third extended wire 33 are formed in the via opening portion through, for example, plating, and the first external terminal 41, the second external terminal 42, and the third external terminal 43 are further formed on the insulating film 50. In this manner, the inductor component 1 is manufactured. A plurality of the inductor components 1 may be separated from each other through cutting with a dicing machine to manufacture each of the inductor components 1.

### Second Exemplary Embodiment

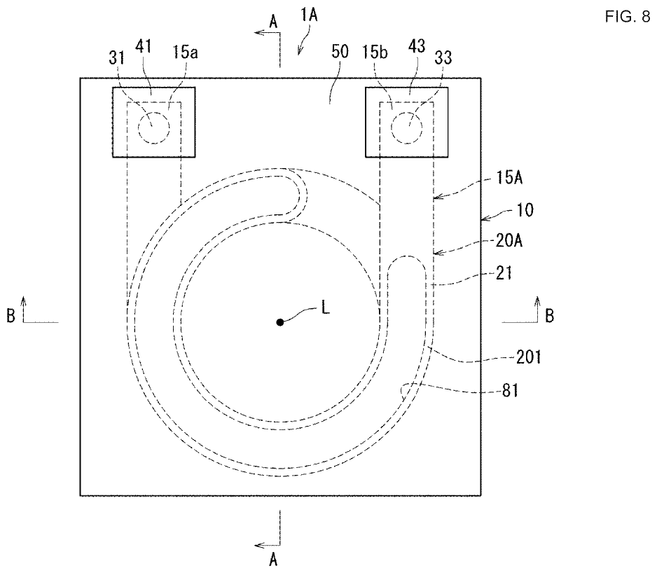

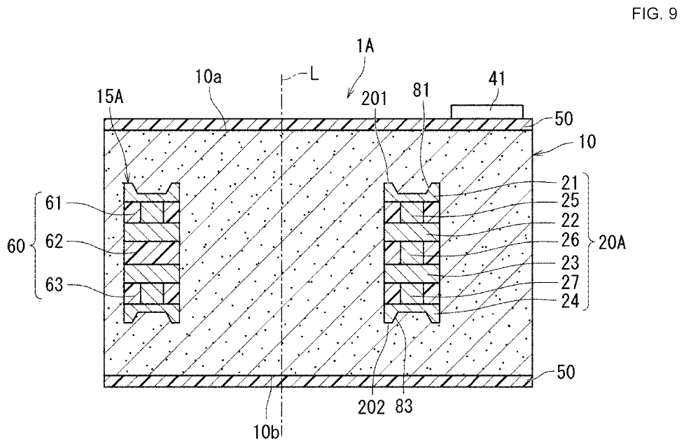

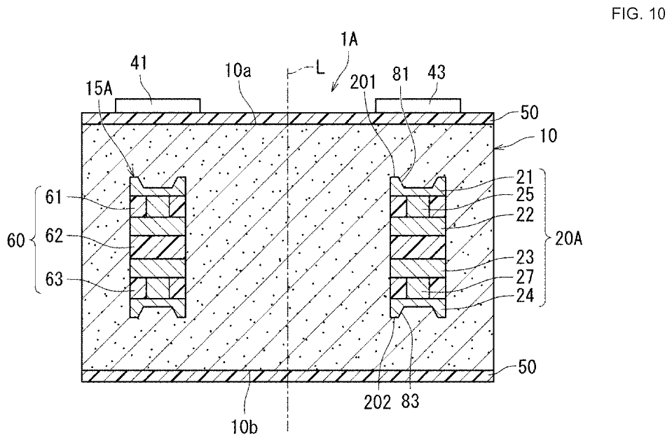

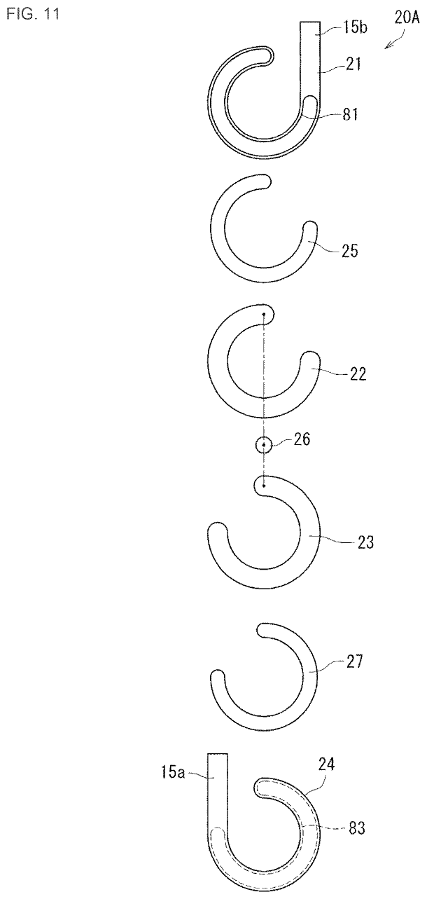

FIG. 8 is a plan view showing a second embodiment of an inductor component. FIG. 9 is a sectional view taken along line A-A in FIG. 8. FIG. 10 is a B-B sectional view in FIG. 8. FIG. 11 is an exploded plan view of a coil. The second embodiment is different from the first embodiment in a configuration of the coil and a configuration of the external terminal. The different configuration will be described below. Other configurations are the same configurations as those of the first embodiment, and the same reference numerals as those of the first embodiment will be assigned, and description thereof will be omitted.

As shown in FIGS. 8, 9, 10, and 11, in an inductor component 1A of the second embodiment, compared to the inductor component 1 of the first embodiment, the configuration of a coil wire 20A of a coil 15A is different. In addition, in the inductor component 1A of the second embodiment, compared to the inductor component 1 of the first embodiment, the configuration is different in that the second extended wire 32 and the second external terminal 42 of the first embodiment are not provided.

The coil wire 20A includes a first coil conductor layer 21, a second coil conductor layer 22, a third coil conductor layer 23, and a fourth coil conductor layer 24 which are laminated along the axis L, a first connection conductor layer 25 that connects the first coil conductor layer 21 and the second coil conductor layer 22 which are adjacent to each other in the direction of the axis L, a second connection conductor layer 26 that connects the second coil conductor layer 22 and the third coil conductor layer 23 which are adjacent to each other in the direction of the axis L, and a third connection conductor layer 27 that connects the third coil conductor layer 23 and the fourth coil conductor layer 24 which are adjacent to each other in the direction of the axis L.

Each of the first coil conductor layer 21, the second coil conductor layer 22, the third coil conductor layer 23, and the fourth coil conductor layer 24 extends along a plane orthogonal to the axis L. Each of the first coil conductor layer 21, the second coil conductor layer 22, the third coil conductor layer 23, and the fourth coil conductor layer 24 has a spiral shape smaller than one turn. The first coil conductor layer 21 and the second coil conductor layer 22 have substantially the same shape having the same turn, and the third coil conductor layer 23 and the fourth coil conductor layer 24 have substantially the same shape having the same turn.

Each of the first connection conductor layer 25 and the third connection conductor layer 27 extends along a plane orthogonal to the axis L. Each of the first connection conductor layer 25 and the third connection conductor layer 27 has a spiral shape smaller than one turn. The first connection conductor layer 25 has substantially the same shape having the same turn as those of the first coil conductor layer 21, and the third connection conductor layer 27 has substantially the same shape having the same turn as those of the fourth coil conductor layer 24. The second connection conductor layer 26 extends along the axis L. The second connection conductor layer 26 is formed in a disk shape.

The width of the first connection conductor layer 25 is smaller than the width of the first coil conductor layer 21 and the width of the second coil conductor layer 22. The width of the third connection conductor layer 27 is smaller than the width of the third coil conductor layer 23 and the width of the fourth coil conductor layer 24. The width is the length in a direction orthogonal to an extending direction.

The first coil conductor layer 21 and the second coil conductor layer 22 are connected in parallel with the first connection conductor layer 25 interposed therebetween. That is, the first coil conductor layer 21, the second coil conductor layer 22, and the first connection conductor layer 25 are in surface contact with each other. One end of the second coil conductor layer 22 and one end of the third coil conductor layer 23 are connected in series with the second connection conductor layer 26 interposed therebetween. The third coil conductor layer 23 and the fourth coil conductor layer 24 are connected in parallel with the third connection conductor layer 27 interposed therebetween. That is, the third coil conductor layer 23, the fourth coil conductor layer 24, and the third connection conductor layer 27 are in surface contact with each other. In this manner, the first coil conductor layer 21 and the second coil conductor layer 22, and the third coil conductor layer 23 and the fourth coil conductor layer 24 are electrically connected in series.

The first recess 81 is provided in the upper surface of the first coil conductor layer 21. The third recess 83 is provided in the lower surface of the fourth coil conductor layer 24. In the second embodiment, the second recess 82 and the fourth recess 84 of the first embodiment are not provided.

The first recess 81 extends in the extending direction of the first coil conductor layer 21. The shape of the first recess 81 is substantially the same as the shape of the first connection conductor layer 25 when viewed in the direction of the axis L. The third recess 83 extends in the extending direction of the fourth coil conductor layer 24. The shape of the third recess 83 is substantially the same as the shape of the third connection conductor layer 27 when viewed in the direction of the axis L.

The first recess 81 and the first connection conductor layer 25 extend in the extending direction of the first coil conductor layer 21. Therefore, a surface area of the coil wire 20A is further increased. Similarly, the third recess 83 and the third connection conductor layer 27 extend in the extending direction of the fourth coil conductor layer 24. Therefore, the surface area of the coil wire 20A is further increased. In this manner, an outer peripheral length of a section of the coil wire 20A is further increased with respect to a sectional area of the coil wire 20A. As a result, it is possible to obtain the inductor component 1A having a small loss and which can suppress an AC resistance increase caused by a skin effect.

As in the first embodiment, the first recess 81 and the third recess 83 can be formed by control. For example, when the first coil conductor layer 21 and the fourth coil conductor layer 24 are formed through plating, the first recess 81 and the third recess 83 are formed by controlling plating conditions. The first recess 81 and the third recess 83 may be mechanically formed through cutting, polishing, or the like.

The first recess 81 and the first connection conductor layer 25 overlap each other in the direction of the axis L. Accordingly, the first recess 81 and the first connection conductor layer 25 are located on the same section including the axis L. Therefore, the first coil conductor layer 21 includes the first recess 81, and the sectional area of the first coil conductor layer 21 is reduced. However, the first connection conductor layer 25 is connected to the first coil conductor layer 21. Therefore, the sectional area of the first coil conductor layer 21, that is, the coil wire 20A can be secured, and electrical resistance of the coil wire 20A is reduced.

Similarly, the third recess 83 and the third connection conductor layer 27 overlap each other when viewed in the direction of the axis L. Accordingly, the third recess 83 and the third connection conductor layer 27 are located on the same section including the axis L. Therefore, the fourth coil conductor layer 24 includes the third recess 83, and the sectional area of the fourth coil conductor layer 24 is reduced. However, the third connection conductor layer 27 is connected to the fourth coil conductor layer 24. Therefore, the sectional area of the fourth coil conductor layer 24, that is, the coil wire 20A can be secured, and electrical resistance of the coil wire 20A is reduced.

The insulator 60 includes a first insulating layer 61, a second insulating layer 62, and a third insulating layer 63. The first connection conductor layer 25 penetrates the first insulating layer 61. The second connection conductor layer 26 penetrates the second insulating layer 62. The third connection conductor layer 27 penetrates the third insulating layer 63.

The manufacturing method for the inductor component 1A of the second embodiment is substantially the same as the manufacturing method for the inductor component 1 of the first embodiment. In the second embodiment, compared to the first embodiment, the first recess 81 and the first connection conductor layer 25 are provided to extend in the extending direction of the first coil conductor layer 21, and the third recess 83 and the third connection conductor layer 27 are provided to extend in the extending direction of the fourth coil conductor layer 24.

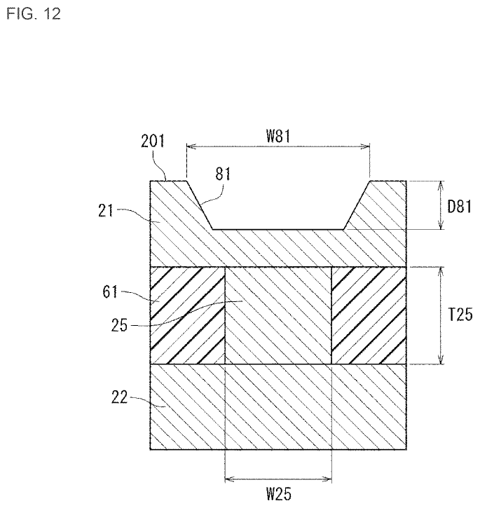

FIG. 12 is a partially enlarged view in FIG. 10. As shown in FIG. 12, in the section including the axis L and intersecting the first recess 81 and the first connection conductor layer 25, a depth D81 of the first recess 81 is the same as or larger than a thickness T25 of the first connection conductor layer 25. The thickness T25 of the first connection conductor layer 25 is the same as the thickness of the first insulating layer 61.

The depth and the thickness are the lengths in the direction of the axis L. A measuring method for the depth and the thickness will be described. In the section of the coil 15 including the axis L and intersecting the first recess 81 and the first connection conductor layer 25, a line in contact with both right and left ends of the upper portion of the first recess 81 of the first coil conductor layer 21 is defined as a reference line, and a maximum length of the first recess 81 in the direction of the axis L from the reference line to a bottom portion of the first recess 81 is defined as the depth of the first recess 81. In addition, in the section, two parallel lines orthogonal to the axis L which are in contact with the upper end and the lower end of the first insulating layer 61 are defined, and an interval between the two parallel lines is defined as the thickness of the first insulating layer 61. The thickness T25 of the first connection conductor layer 25 is the same as the thickness of the first insulating layer 61.

According to the above-described configuration, the depth D81 of the first recess 81 is the same as or larger than the thickness T25 of the first connection conductor layer 25. Therefore, the volume of the magnetic material is further increased, and the inductance value is further improved. In addition, the depth D81 of the first recess 81 is the same as or larger than the thickness T25 of the first connection conductor layer 25. Therefore, the anchor effect is improved, and adhesion between the element body 10 and the coil wire 20A is further improved.

Similarly, the depth of the fourth recess 84 may be the same as or larger than the thickness of the third connection conductor layer 27. In this manner, the volume of the magnetic material is further increased, and the inductance value is further improved. Additionally, the anchor effect is improved, and adhesion between the element body 10 and the coil wire 20A is further improved.

As shown in FIG. 12, in the section including the axis L and intersecting the first recess 81 and the first connection conductor layer 25, an opening width W81 of the first recess 81 is the same as or larger than a width W25 of the first connection conductor layer 25.

The opening width is the width of an opening end. The width is the length in the direction orthogonal to the axis L. A measuring method for the width will be described. In the section of the coil 15 including the axis L and intersecting the first recess 81 and the first connection conductor layer 25, a line in contact with both right and left ends of the upper portion of the first recess 81 of the first coil conductor layer 21 is defined as the reference line, and a distance between the reference line and two contact points of the first coil conductor layer 21 is defined as the opening width.

According to the above-described configuration, the opening width W81 of the first recess 81 is the same as or larger than the width W25 of the first connection conductor layer 25. Therefore, the volume of the magnetic material is further increased, and the inductance value is further improved. In addition, the opening width W81 of the first recess 81 is the same as or larger than the width W25 of the first connection conductor layer 25. Therefore, the anchor effect is improved, and adhesion between the element body 10 and the coil wire 20A is further improved.

Similarly, the opening width of the fourth recess 84 may be the same as or larger than the width of the third connection conductor layer 27. In this manner, the volume of the magnetic material is further increased, and the inductance value is further improved. Additionally, the anchor effect is improved, and adhesion between the element body 10 and the coil wire 20A is further improved.

### Third Exemplary Embodiment

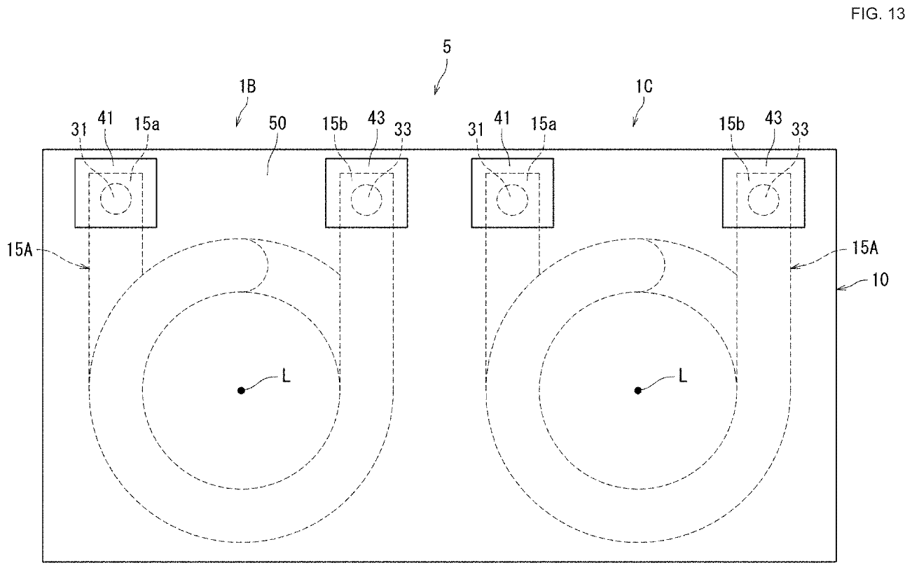

FIG. 13 is a plan view showing an exemplary embodiment of an inductor array. As shown in FIG. 13, an inductor array 5 includes a first inductor component 1B and a second inductor component 1C. Each of the first inductor component 1B and the second inductor component 1C has the same configuration as that of the inductor component 1A of the second embodiment.

The first inductor component 1B and the second inductor component 1C are arrayed on the same plane orthogonal to the axis L such that the axes L of the respective coils 15A are parallel to each other. According to an exemplary aspect, the first inductor component 1B and the second inductor component 1C are electrically independent. The first external terminal 41 and the third external terminal 43 of the first inductor component 1B and the first external terminal 41 and the third external terminal 43 of the second inductor component 1C are linearly arrayed along the direction orthogonal to the axis L.

According to the above-described configuration, the inductor components 1B and 1C having the same configuration as that of the inductor component 1A of the second embodiment are provided. Therefore, the thickness of the inductor components 1B and 1C can become smaller to achieve a thinner inductor array. As a result, the thickness of the inductor array 5 can become smaller.

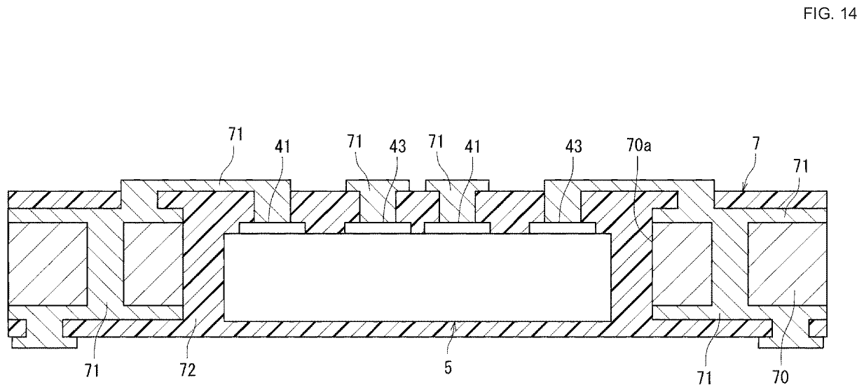

FIG. 14 is a sectional view showing a state where the inductor array 5 is incorporated into a substrate 7. In FIG. 14, for convenience, the inductor array 5 is not hatched. As shown in FIG. 14, the inductor array 5 is incorporated into the substrate 7. The substrate 7 includes a core material 70, a wiring portion 71, and a resin member 72. The inductor array 5 is disposed inside a through-hole 70a of the core material 70. The resin member 72 seals the inductor array 5 and the substrate 7. The wiring portion 71 is provided to extend to the core material 70 and the resin member 72 and is connected to the external terminals 41 and 43 of the inductor array 5. In this manner, the inductor array 5 can become thinner. Therefore, the substrate 7 can become thinner.

### Fourth Exemplary Embodiment

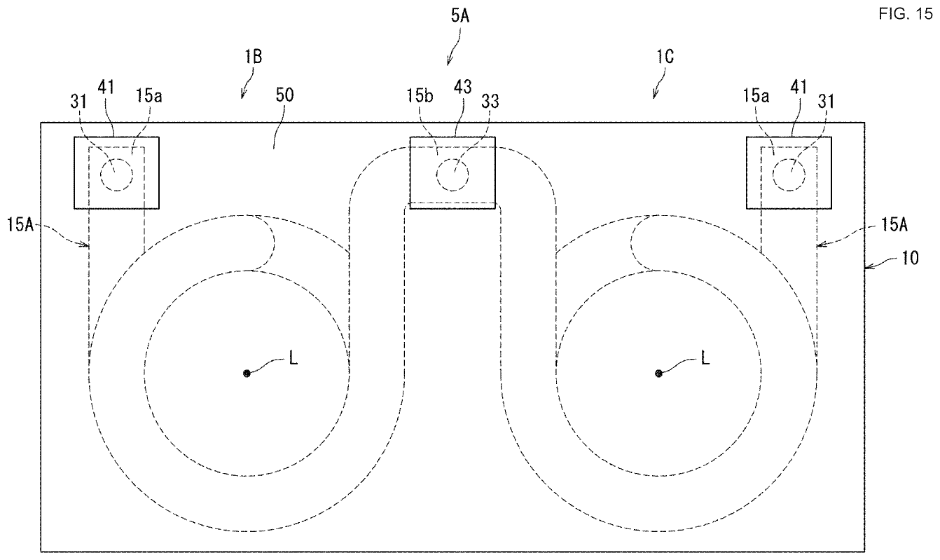

FIG. 15 is a plan view showing an exemplary embodiment of an inductor array. A fourth embodiment is different from the third embodiment in the disposition of the coil. The different configuration will be described below. Other configurations are the same as the configurations of the third embodiment. The same reference numerals as those of the third embodiment will be assigned, and description thereof will be omitted.

As shown in FIG. 15, in the inductor array 5A, the first inductor component 1B and the second inductor component 1C are electrically connected in series. According to an exemplary aspect, the second end portion 15b of the coil 15A of the first inductor component 1B and the second end portion 15b of the coil 15A of the second inductor component 1C are common members. That is, the first inductor component 1B and the second inductor component 1C have the common third extended wire 33 and the common third external terminal 43. In this way, the inductor array 5A includes two sets of the first extended wire 31 and the first external terminal 41, and one set of the third extended wire 33 and the third external terminal 43.

According to the above-described configuration, in addition to the advantageous effect of the inductor array 5 of the third embodiment, the size of the inductor array 5A is reduced by using the members in common.

The present disclosure is not limited to the above-described exemplary embodiments, and can be modified as appropriate within the scope not departing from the concept of the present disclosure. For example, respective characteristic points of the first to fourth embodiments may be combined in various ways.

In the first embodiment and the second embodiment, the coil wire includes the four coil conductor layers. However, the coil wire may include two or more coil conductor layers. In addition, the coil wire may be formed to continuously proceed along the axis. For example, the coil wire may be formed by spirally winding a flat plate-shaped (flat) conductor along the axis.

In the first embodiment and the second embodiment, the recess is provided in both the first end surface and the second end surface of the coil wire. However, the recess may be provided in at least one end surface of the first end surface and the second end surface of the coil wire.

In the first embodiment, as in the second embodiment, in the section including the axis and intersecting the first recess and the first connection conductor layer, the depth of the first recess may be the same as or larger than the thickness of the first connection conductor layer. The depth of the fourth recess may be the same as or greater than the thickness of the third connection conductor layer. In this manner, the volume of the magnetic material is further increased, the inductance value is further improved. Additionally, the anchor effect is improved, and adhesion between the element body and the coil wire is further improved.

In the first embodiment, as in the second embodiment, in the section including the axis and intersecting the first recess and the first connection conductor layer, the opening width of the first recess may be the same as or larger than the width of the first connection conductor layer. The opening width of the fourth recess may be the same as or larger than the width of the first connection conductor layer. In this manner, the volume of the magnetic material is further increased, the inductance value is further improved. Additionally, the anchor effect is improved, and adhesion between the element body and the coil wire is further improved.

In the third embodiment, the inductor array uses only the inductor component of the second embodiment. However, the inductor component of the first embodiment and the inductor component of the second embodiment may be used, or only the inductor component of the first embodiment may be used. In addition, the inductor array may have three or more inductor components.

In the third embodiment, the first inductor component and the second inductor component are arrayed on the same plane orthogonal to the axis such that the axes of the respective coils are parallel to each other. However, as long as the first inductor component and the second inductor component are arrayed on the same plane, the axes of the respective coils do not need to be parallel to each other.

### REFERENCE SIGNS LIST

1, 1A inductor component
1B first inductor component
1C second inductor component
5, 5A inductor array
7 substrate
10 element body
10a first surface
10b second surface
15, 15A coil
15a first end portion
15b second end portion
20, 20A coil wire
201 first end surface
202 second end surface
21 to 24 first to fourth coil conductor layers
25 to 27 first to third connection conductor layers
31 to 34 first to fourth extended wires
41 to 43 first to third external terminals
50 insulating film
60 insulator
61 to 63 first to third insulating layers
81 to 86 first to sixth recesses
L axis of coil
D81 depth of first recess
T25 thickness of first connection conductor layer
W81 width of first recess
W25 width of first connection conductor layer

What is claimed:

1. An inductor component comprising:
an element body including a magnetic material; and
a coil inside the element body and that includes a coil wire that is spirally wound along an axis with a first end of the coil wire at a positive side of the axis and a second end of the coil wire at a negative side of the axis,
wherein at least one of a first end surface of the first end of the coil wire and a second end surface of the second end of the coil wire includes a recess, and
wherein a portion of the element body is inside the recess.

2. The inductor component according to claim 1, wherein: the coil wire includes:
a plurality of coil conductor layers laminated along the axis; and
at least a first connection conductor layer that connects a first coil conductor layer in the plurality of coil conductor layers and a second coil conductor layer in the plurality of coil conductor layers that are adjacent to each other along the axis;
wherein each of the plurality of coil conductor layers extends in a plane orthogonal to the axis; and
wherein the recess and the first connection conductor layer overlap each other when viewed in a direction of the axis.

3. The inductor component according to claim 2, wherein a depth of the recess in the direction of the axis is of a same value as or is larger than a thickness of the first connection conductor layer.

4. The inductor component according to claim 2, wherein an opening width of the recess is of a same value as or is larger than a width of the first connection conductor layer.

5. The inductor component according to claim 1, wherein the element body comprises a composite material of a metal magnetic powder and an organic material.

6. The inductor component according to claim 1, wherein:
the coil further includes an insulator that covers at least a portion of the coil wire; and
the insulator comprises a composite material of at least one of a non-magnetic inorganic material and an organic material.

7. The inductor component according to claim 1, further comprising at least an external terminal that is disposed on an outer surface of the element body and is electrically connected to the coil.

8. The inductor component according to claim 7, further comprising an insulating film disposed between a portion of the external terminal and the outer surface of the element body.

9. The inductor component according to claim 7, wherein:
the outer surface of the element body includes a first surface and a second surface that face each other;
the inductor component includes:
a first external terminal on the first surface; and
a second external terminal on the second surface; and
the first external terminal and the second external terminal are configured to have a same potential.

10. An inductor array comprising:
a plurality of inductor components that are arrayed on a same plane, wherein:
at least a first inductor component in the plurality of inductor components comprises:
an element body including a magnetic material; and
a coil that inside the element body and including a coil wire that is spirally wound along an axis with a first end of the coil wire at a positive side of the axis and a second end of the coil wire at a negative side of the axis;
at least one of a first end surface of the first end of the coil wire and a second end surface of the second end of the coil wire includes a recess; and
a portion of the element body is located inside the recess.

11. The inductor array according to claim 10, wherein the coil wire includes:
a plurality of coil conductor layers laminated along the axis; and
at least a first connection conductor layer that connects a first coil conductor layer in the plurality of coil conductor layers and a second coil conductor layer in the plurality of coil conductor layers that are adjacent to each other along the axis;
wherein each of the plurality of coil conductor layers extends in a plane orthogonal to the axis; and
wherein the recess and the first connection conductor layer overlap each other when viewed in a direction of the axis.

12. The inductor array according to claim 11, wherein a depth of the recess in the direction of the axis is of a same value as or is larger than a thickness of the first connection conductor layer.

13. The inductor array according to claim 11, wherein an opening width of the recess is of a same value as or is larger than a width of the first connection conductor layer.

14. The inductor array according to claim 10, wherein the element body comprises a composite material of a metal magnetic powder and an organic material.

15. The inductor array according to claim 10, wherein:
the coil further includes an insulator that covers at least a portion of the coil wire; and
the insulator comprises a composite material of at least one of a non-magnetic inorganic material and an organic material.

16. The inductor array according to claim 10, wherein the first inductor component further comprises at least an external terminal that is disposed on an outer surface of the element body and is electrically connected to the coil.

17. The inductor array according to claim 16, wherein the first inductor component further comprises an insulating film between a portion of the external terminal and the outer surface of the element body.

18. The inductor array according to claim 16, wherein:
the outer surface of the element body includes a first surface and a second surface that face each other;
the first inductor component includes:
a first external terminal on the first surface; and
a second external terminal on the second surface; and
the first external terminal and the second external terminal are configured to have a same potential.

19. An inductor component comprising:
an element body including a magnetic material; and
a coil that is inside the element body and that includes a coil wire that is spirally wound in a plurality of coil conductor layers along an axis, wherein:
at least one of the plurality of coil conductor layers includes a recess; and
a portion of the element body is inside the recess.

20. The inductor component according to claim 19, wherein the recess is in a coil conductor layer that forms an end of the coil wire.
